(19) United States
(12) Patent Application Publication
(10) Pub. No.: US 2025/0001391 A1
(43) Pub. Date: Jan. 2, 2025

(54) FUNCTIONALIZED CARBON-MODIFIED FOAMED GLASS CERAMICS AND PFAS REMOVAL BY USE OF CARBON-MODIFIED FOAMED GLASS CERAMICS

(71) Applicant: BATTELLE SAVANNAH RIVER ALLIANCE, LLC, AIKEN, SC (US)

(72) Inventors: WILLIAM C. JOLIN, EVANS, GA (US); CORY L. TRIVELPIECE, AIKEN, SC (US); ALEX J. KUGLER, RICHLAND, WA (US)

(21) Appl. No.: 18/752,966

(22) Filed: Jun. 25, 2024

Related U.S. Application Data
(60) Provisional application No. 63/510,910, filed on Jun. 29, 2023.

(51) Int. Cl. B01J 20/22; B01J 20/20; B01J 20/28; B01J 20/30; B01J 20/32; C02F 1/28; C02F 101/00; C02F 101/20; C02F 101/36

(52) U.S. Cl. CPC B01J 20/223; B01J 20/20; B01J 20/28045; B01J 20/3078; B01J 20/3085; B01J 20/3204; C02F 1/288; C02F 2101/006; C02F 2101/20; C02F 2101/36

(57) ABSTRACT

Described is a separation material, methods for forming the material, and methods for using the material. The material in one embodiment includes a foamed glass and a targeting sorbent functionality for a targeted analyte directly or indirectly affixed to the material via oxidized carbons at the surface of the foamed glass. Disclosed materials can be utilized to remove environmental contaminants from an area of interest, such as removal of PFAS from contaminated water.

### CROSS REFERENCE TO RELATED APPLICATION

This application claims filing benefit of U.S. Provisional Patent Application Ser. No. 63/510,910 entitled “Functionalized Carbon-Modified Foamed Glass Ceramics,” having a filing date of Jun. 29, 2023, which is incorporated herein by reference for all purposes.

### FEDERAL RESEARCH STATEMENT

This invention was made with Government support under Contract No. 893033210EM00080, awarded by the U.S. Department of Energy. The Government has certain rights in the invention.

### BACKGROUND

Micropollutants, including toxic anions and heavy metals, are ubiquitous in both groundwater and landfill leachate across the United States. One class of pollutants that is of significant concern is poly-and perfluoroalkyl substances (PFAS) such as perfluorooctanoic acid (PFOA) and perfluorooctanesulfonic acid (PFOS). This class of synthetic compounds has been mass-produced since the 1940s. PFAS exhibit excellent chemical and thermal stability and have been used in a wide range of industrial and consumer products such as firefighting foams, food packaging, water and stain repellents, cleaning products, paints, sealants, personal care products, non-stick cookware, etc. As a result of strong stability and persistence in a variety of media, PFAS are among those termed “forever chemicals.”

Exposure to such pollutants may pose significant threats to human and animal health, including negative reproductive effects, developmental effects or delays, increased risk of some cancers, and reduced ability of the body's immune system to fight infections. PFOA and PFOS have been the most widely used PFAS, and their production has been banned due to such concerns.

Methods of capturing such pollutants are largely non-selective, meaning sorbents such as activated carbons do not target specific contaminants of concern. This non-selectivity results in competition effects from background ions and other media constituents. Pursuant of this, the modification of activated carbon by the attachment of functional groups targeting specific contaminants has been widely examined. Nitrates, iodates, and sulfates have been targeted with both nickel and zinc impregnation creating positively charged complexation sites on the surface of modified activated carbon. The attachment of chelators to the surface of activated carbon has also been examined toward the selective removal of heavy metals and radionuclides from solution.

Unfortunately, functionalization by both metal impregnation and chelator attachment generally requires the modification of the activated carbon surface by destructive oxidation to prepare the surface for modification. This destruction depletes the structural integrity of the activated carbon and greatly limits the application of the functionalized activated carbon. Moreover, activated carbon shows a rapid breakthrough of many pollutants, including PFAS compounds.

Currently utilized spent media requires proper handling and disposal, particularly when considering spent media containing forever chemicals such as PFAS. Thermal treatment (e.g., up to 1000° C. in direct, gas-fired rotary kilns or vertical furnaces) is the current common industry practice for managing PFAS-laden activated carbon. Unfortunately, conventional thermal treatment systems require large equipment facilities and are characterized by long processing times, high energy consumption, and long transport distances from the utilities to the regional regeneration facilities.

Engineered cellular magmatics (ECMs) are a transformative evolution of foamed glass. ECMs are synthetic, open-or closed-cell, porous glass ceramics produced from post-consumer (i.e., “recycled”) waste glass. During the upcycling process, glass that is often destined for a landfill is fired at temperatures below the liquidus temperature of the original glass in the presence of a foaming agent.

Needed in the art are sorbents that can be utilized to remove pollutants with high efficiency. Methods for separation of forever chemicals such as PFAS from polluted sources would be of great benefit to the art.

### SUMMARY

According to one embodiment, disclosed are functionalized engineered cellular magmatics (ECMs) that include a foamed glass and a targeting sorbent functionality directly or indirectly bonded to a surface of the foamed glass. The targeting sorbent functionality can be specific for a particular analyte, e.g., a toxic anion, a heavy metal, a radionuclide, etc. The targeting sorbent functionality can be directly or indirectly bonded to the surface of the foamed glass via a carboxyl functionality at a surface of the foamed glass.

Also disclosed are methods for forming functionalized ECM. A method can include combining a glass with a foaming agent to form a mixture. The foaming agent can include carbon. In one embodiment, the foaming agent can include activated carbon. A method can also include subjecting the mixture to thermal treatment in air, leading to formation of carbon dioxide and pore creation in the glass and also leaving carbon bonded or adhered at a surface of the foamed glass. Upon oxidation, the carbon can be oxidized to form carboxyl groups at the surface of the foamed glass. A method can further include addition of a targeting sorbent functionality to the foamed glass via reaction with the carboxyl groups. For instance, a targeting sorbent functionality can be directly bonded to a surface of a foamed glass via reaction with a carboxyl group at the surface. In one embodiment, a linking agent can be bonded to the surface of the foamed glass via reaction with a carboxyl group and a targeting sorbent functionality can be bonded to the foamed glass via reaction with the linking agent, thereby bonding the sorbent functionality indirectly to the surface via the linking agent.

Methods for utilizing ECMs are also described. For instance, a method can include contacting an ECM that includes a foamed glass and carbon bonded or adhered at a surface of the foamed glass with an aqueous media that contains a PFAS. Upon the contact, the ECM can sorb the PFAS and remove the PFAS from the aqueous media.

In one embodiment, a method can include contacting a functionalized ECM that includes a foamed glass and a targeting sorbent functionality directly or indirectly bonded to the foamed glass via a carboxyl group with a contaminant, e.g., contacting the functionalized ECM with a polluted water source. Upon contact, the targeted contaminant can preferentially sorb to the ECM via the targeting sorbent functionality. A method can also include removing the functionalized ECM, which now includes the sorbed contaminant, from the site for disposal.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIG. 1 illustrates a synthesis method for forming ECM that includes a foamed glass and carbon at a surface thereof.

FIG. 2 illustrates a method of utilizing ECM as described in removal of a contaminate from a source.

FIG. 3 illustrates a method for surface modifying a foamed glass to form a functionalized ECM as described herein.

### DETAILED DESCRIPTION

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment, may be used in another embodiment to yield a still further embodiment.

In general, the present disclosure is directed to ECM for use in removing pollutants from contaminated media and to methods for forming and utilizing the ECM. In one embodiment, the ECM can be utilized in removing PFAS from a contaminated source, e.g., contaminated water. In one embodiment, the ECM can be utilized in removing a contaminant by specific targeting of the ECM to the pollutant.

Beneficially, porous, glass based substrates (also referred to throughout this disclosure as foamed glass or foamed glass ceramics (FGC)) of disclosed ECMs, can be upcycled from post-consumer waste glass and waste-to-energy ash streams. Such upcycling can provide a porous, fixed scaffold in commodity form. Disclosed methods can leverage the porous foamed glass structure as a scaffold to support a sorbent for a targeted pollutant. For instance, an ECM as disclosed herein can include a porous, glass-based substrate and added carbon for targeting PFAS for removal from a contaminated source. In one embodiment, ECM can include a targeting sorbent functionality affixed to the surface the substrate that can target specific contaminant materials, for instance contaminants of concern as may be present in a water source or in an environmental cleanup site.

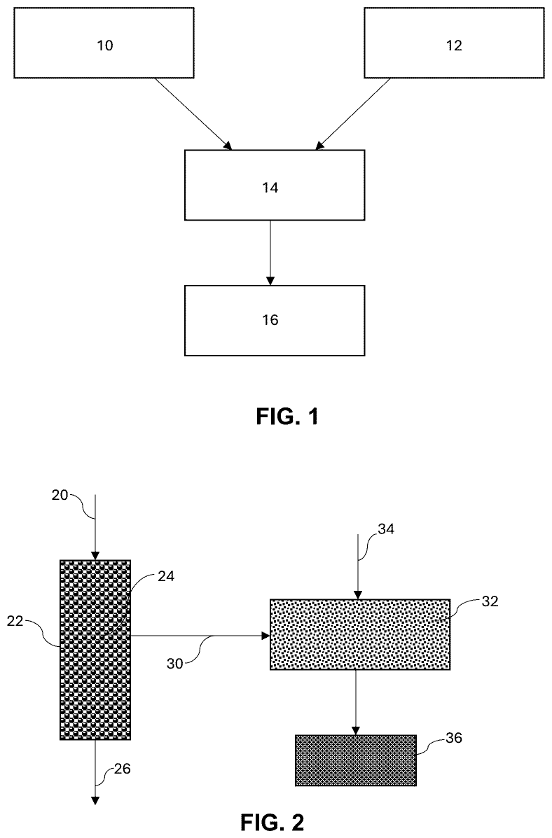

FIG. 1 illustrates one method for forming carbon-containing ECM as may utilized in disclosed methods. As indicated, glass 10 can be combined with a foaming agent 12 and processed 14 to form an ECM 16.

The glass 10 utilized to form the ECM materials can be a natural or synthetic glass. In one embodiment, an ECM 16 can be formed from post-consumer recycled glass. As utilized herein, the term “glass” generally refers to a non-crystalline silicate material. In some embodiments, a glass can include silicon dioxide. However, a glass is not limited to any particular silicate material and can encompass, without limitation, natural pumice or synthetic equivalents, natural obsidian or synthetic equivalents, natural perlite or synthetic equivalents, soda-lime glass, flint, container glass, a-glass, flat glass, e-glass, c-glass, ar-glass, s-glass, niobophosphate glass, single-phase borosilicate glass, phase separated borosilicate glass, fused silica, coal slags, metal slags, smelting slags, mineral wool, or ash byproducts from incineration processes, as well as any combinations thereof.

Glass 10 for use in forming disclosed materials can include a glass in conjunction with one or more additional materials, e.g., an amorphous material in conjunction with a secondary material, which can be a crystalline or non-crystalline material, including one or more different glasses. By way of example, and without limitation, a glass-based substrate can include one or more of alumina, alumina hydrate, aplite, feldspar, nepheline syenite, calumite, kyanite, kaolin, cryolite, antimony oxide, arsenious oxide, barium carbonate, barium oxide, barium sulfate, boric acid, borax, anhydrous borax, quicklime, calcium hydrate, calcium carbonate, dolomitic lime, dolomite, finishing lime, litharge, minium, calcium phosphate, bone ash, iron oxide, caustic potash, saltpeter, potassium carbonate, hydrated potassium carbonate, sand, diatomite, soda ash, sodium nitrate, sodium sulphate, sodium silica-fluoride, pyrolysis ash, zinc oxide, or any combination thereof.

As indicated in FIG. 1, the starting glass 10, e.g., post-consumer glass, can be combined with a foaming agent 12 to form a mixture. The mixture can then be subject to processing 14, which can include a thermal treatment during which the foaming agent can decompose, creating pores in the structure of the ECM. The particular method for forming the ECM 16 is not critical, and methods as previously known in the art may be utilized. For instance, the particular composition of the ECM 16 can be controlled during pre-firing batching, and the physical properties of the materials can be controlled via chemical composition of the batch in addition to process parameters as described further in U.S. Patent Application Publications 2022/0073416, 2022/0081349, and 2022/0089476 all to Hust et al., which are incorporated herein by reference in their entirety.

The foaming agent 12 can include a source of carbon. In one embodiment, the foaming agent 12 can include activated carbon. In some embodiments, a foaming agent 12 can include a combination of multiple different materials. For example, in one embodiment, a foaming agent 12 can include calcium carbonate, optionally in combination with activated carbon, or one or more other sources of carbon. The selection of a particular foaming agent 12 can be utilized to vary the structure and characteristics of the ECM 16, as is known. In some embodiments, a foaming agent 12, e.g., activated carbon, can be combined with glass 10 in conjunction with an oxidation agent.

Processing 14 of the mixture can include thermally treating (e.g., firing) the mixture at a temperature that is less than the liquidus temperature of the glass 10. Upon the thermal treatment in the presence of oxygen, e.g., air, the foaming agent 12 can form carbon dioxide, which in turn can form pores within the structure of the glass 10 at the firing temperature. The thermal treatment can also leave a residual portion of carbon from the foaming agent 12 on the surface of the ECM pores, which can be bound or otherwise adhered to the surface of the ECM. In one embodiment, the surface carbon present following an ECM formation process as illustrated in FIG. 1 can include a least a portion of the carbon as oxidized carbon in the form of carboxyl groups at the surface of the foamed glass substrate. By way of example, the formed ECM 16 can include carbon, which can be in the form of elemental carbon or oxidized as carboxyl groups, bonded or adhered to a surface of the foamed glass, in an amount of from about 1 wt. % to about 5 wt. % of the ECM 16.

The ECM 16, which can include carbon at a surface thereof, may include open-celled porosity, i.e., an individual piece of the media may include passageways extending from an external surface of the piece to the interior and/or to a second external surface of the piece. The porosity can be relatively small, with average pore size on the order of hundreds of micrometers, e.g., from about 50 micrometers to about 1000 micrometers, or from about 100 micrometers to about 500 micrometers in some embodiments. In other embodiments, the starting materials and formation parameters can be selected/designed such that the ECM 16 includes a larger porosity, e.g., from about 500 micrometers to about 2 millimeters, or even larger, in some embodiments.

In some embodiments, the ECM 16 can have a single, well-defined porosity. For instance, a silicate aggregate ECM 16 having a single composition with highly homogenous and/or uniform properties, e.g., a single density and a single porosity. In other embodiments, a more complex material can be utilized. For instance, an ECM can include vitreous materials contained at least partially within pores of the base foamed glass substrate material, leading to regions of the ECM 16 that are mesoporous (less than about 100 micrometers in cross-section) and/or microporous (less than about 1 micrometer in cross-section).

The bulk density and surface area (e.g., BET surface area) of ECM 16 are not particularly limited. For instance, in some embodiments, ECM 16 can have a bulk density of from about 0.1 grams per centimeter (g/cc) to about 2 g/cc, such as from about 0.8 to about 4 g/cc, or from about 1 g/cc to about 3 g/cc, in some embodiments. In general, BET surface area can be about 100 square meters per gram (m²/g) or less, such as about 5 m²/g or less, or about 2 m²/g or less, in some embodiments, e.g., from about 0.1 m²/g to about 1 m²/g.

A formed ECM 16 can have any desirable shape and size. In general, ECM 16 can be in the form of an aggregate, i.e., a plurality of individual pieces, typically having a largest cross-sectional size on the order of about 50 millimeters or less, such as about 25 millimeters or less, such as from about 1 millimeter to about 20 millimeters, or from about 2 millimeters to about 10 millimeters, in some embodiments. The individual particles of ECM 16 can likewise be provided in any suitable bulk shape, e.g., spherical, polyhedral, or nebulous shapes, as well as a mixture of random bulk shapes.

An ECM 16 that includes a foamed glass and carbon bonded or adhered at a surface of the foamed glass can be utilized in one embodiment in removal of PFAS from a contaminated source, e.g., contaminated water. PFAS as may be adsorbed by an ECM as described can include any PFAS as generally known in the art including, without limitation, perfluorooctanoic acid (PFOA), perfluorooctanesulfonic acid (PFOS), perfluorononanoic acid (PFNA), hexafluoropropylene oxide dimer acid (HFPO-DA), perfluorohexane sulfonic acid (PFHxS), perfluorobutane sulfonic acid (PFBS), or perfluoro butanoic acid (PFBA), as well as any combination thereof.

Methods for separating PFAS from a contaminated source are not particularly limited and need only provide for contact between the contaminated source material, generally in the form of a liquid or dispersion, and an amount of the ECM. By way of example, and without limitation, one method for removal of PFAS from a contaminated source is illustrated in FIG. 2, which includes flow of a contaminated aqueous stream 20 through a filtration column 22 containing ECM 24 that includes foamed glass with carbon at the surface thereof. In general, the ECM 24 can be in the form of a plurality of particles. Prior to or upon break-through of PFAS in the flow 26 out of the column 22, the PFAS-loaded spent ECM can be removed from the column 30 and the column 22 loaded with fresh ECM for further purification processes. Beneficially, a PFAS separation scheme can be carried out at ambient temperatures and pressures, providing for a low-cost treatment.

Spent ECM containing PFAS can be disposed of in a suitable retention facility. In one embodiment, the spent ECM can be disposed of as is, e.g., a plurality of individual PFAS-loaded ECM pieces that can be disposed of in a suitable landfill or other waste disposal site. In one embodiment, the spent ECM can be further treated for more secure long-term fixation. For instance, in one embodiment, the spent ECM 32 can be combined with a binder 34, e.g., a grout, a cement, etc., and water to form a solid waste form 36. Upon cure, the resulting waste form 36 can be disposed in a permanent retention facility and thereby safely retain the PFAS loaded therein.

In one embodiment, ECM materials can be functionalized with one or more targeting sorbent functionalities that can specifically target a pollutant as may be present in a contaminated source. According to this embodiment, a targeting sorbent functionality can be adhered at a surface of a foamed glass by use of ligand attachments. The addition of a targeting sorbent functionality to a foamed glass can increase the filtration capacity the resulting ECM by enhancing the ability of the materials to sorb contaminants of concern from sources such as wastewater, industrial effluent, agricultural runoff, and others.

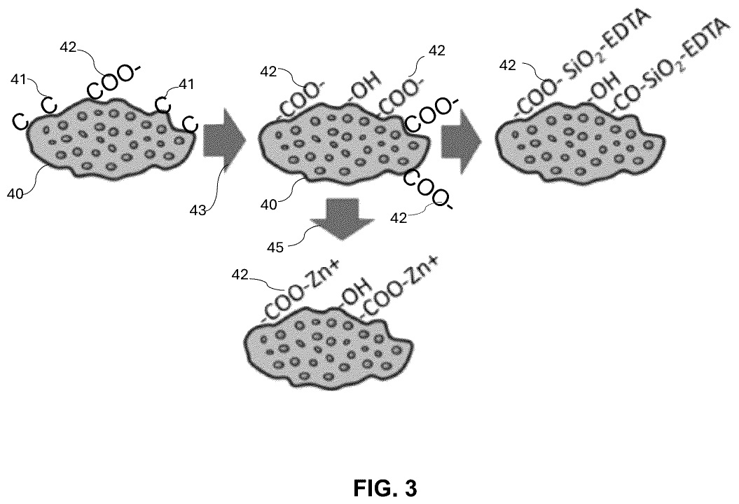

A targeting sorbent functionality can be retained at a surface of a foamed glass by use of surface carbons present on the ECM. As illustrated in FIG. 3, and as discussed previously, upon formation of the foamed glass, carbon 41 of a foaming agent can be retained at the surface of the foamed glass 40. Some of this carbon can be in the oxidized form, e.g., carboxyl functionality 42.

In one embodiment, this carboxyl functionality 42 created during formation of the ECM 40 can be utilized to bond a targeting sorbent functionality to a surface of the ECM. In some embodiments, a further oxidation step 43 can be carried out, in which surface carbon 41 present on the as-formed ECM 40 can be oxidized to provide additional carboxyl functionality 42 on the surface of the ECM 40. In some embodiments, prior to a further oxidation step 43, a surface of the ECM 40 can be mildly corroded to expose additional surface carbon 41 retained at the surface of the foamed glass upon formation of the ECM 40. By way of example, oxidation can be achieved be exposure of the activation carbon within the ECM to dilute nitric acid or other oxidizing agent.

As illustrated in FIG. 3, the oxidized surface carbon, e.g., the carboxyl functionality 42 of the porous ECM 40 can be utilized to further modify the surface structure of the ECM 40 with the foamed glass base substrate providing a supporting scaffold. Without wishing to be bound to any particular theory, it is believed that the underlying foamed glass of the ECM 40 can provide further benefit to the functionalized ECM structures. In particular, it is believed that acidic silanol groups of the underlying foamed glass substrate, while having a weaker affinity for certain functionalizing modifiers, can nevertheless provide for an amount of functionalization bonding sites in addition to the bonding sites of the carboxyl groups 42 and thus increase the overall functionality of the ECMs by directly or indirectly bonding to targeting sorbent functionality.

In some embodiments, the targeting sorbent functionality can directly bond to surface groups of the ECM. For instance, as illustrated in FIG. 3, in one embodiment, a metal (e.g., nickel, zinc, etc.) can be incorporated in the materials through processing steps 45 including aqueous uptake followed by heating to obtain direct attachment of a metal, e.g., Zn⁺ to carboxyl groups 42, as illustrated for zinc in FIG. 3. For instance, positively charged metal ions such as Zn⁺ can sorb to the negatively charged carboxyl groups 42 and thereby impregnate the ECM 40 with the desired metal. Metal impregnation can create a surface complexion sites that can be highly selective towards oxyanions such as nitrates, iodates, or other oxyanions.

In other embodiments, a linking group can be utilized to bind the desired functionality to the ECM. By way of example, and as illustrated in FIG. 3, a linking agent, e.g., tetraethylorthosilicate (TEOS), can provide a silicate-based linkage from surface carboxyl groups 42 to one or more ligands that can provide a desired targeting sorbant functionality, e.g., one or more chelators.

In one embodiment, a targeting sorbent functionality as may be bonded to ECM 40 can include ethylenediaminetetraacetic acid (EDTA) as illustrated in FIG. 3. EDTA is an aminopolycarboxylic acid with the formula [CH₂N(CH₂CO₂H)₂]₂. EDTA is water-insoluble solid and widely used to bind to iron, chromium, copper, and calcium ions (among others). For example, EDTA is a robust chelator of cationic metals and radionuclides.

Other examples of targeting sorbent functionality as may be incorporated on ECM 40 via surface carboxyl groups 40 can include, without limitation, amide, amine, aminopolycarboxyl, carboxylsulfonate, phosphoryl, sulfenyl, and thiol, as well as combinations thereof.

ECMs as described herein can provide a tunable material for contaminant removal in both aqueous and non-aqueous environments. For example, disclosed functionalized ECM materials can be well suited for complex environments including, without limitation, oxidizing atmospheres (e.g., reprocessing off gas) and acidic leachates (e.g., acid mine drainage).

In one embodiment, a functionalized ECM can be utilized to remove one or more targeted analytes from polluted water. For instance, a filtration system such as that illustrated in FIG. 2 can be utilized to target and remove one or more analytes from a polluted water source. Analytes for removal can include, without limitation, toxic anions (e.g., CN⁻, F⁻, PO₄³⁻, AsO₄³⁻, NO³⁻, SCN⁻, HSO³⁻, ClO⁻), heavy metals (e.g., arsenic, cadmium, nickel, mercury, chromium, zinc, lead), radionuclide (e.g., radium, uranium), etc., or any combination thereof.

The present invention may be better understood with reference to the examples set forth below.

### EXAMPLE 1

ECM containing 2% activated carbon was placed in 15.4 mL of 20% HCl and spiked with 2.2 mL (0.02 mmol) TEOS. Samples were agitated at 50° C. for 30 minutes. Following initial incubation 5 mL of a 1:1 mixture of N-[(3-trimethoxysilyl)propyl]-ethylenediamine triacetic acid (TMS-EDTA) and MeOH was added to the reaction vessel (50 mL PP falcon tube). This tube was placed on a rotary shaker at 40° C. and allowed to react overnight.

Samples were washed in a 1:1 solution of 6N HCl and MeOH and placed in a drying oven at 60*C for ˜2 hours.

Removals of ˜10 ppm Fe in solution were tested via batch reactors at pH 2-3 to minimize precipitation effects.

Results included:
Removals with EDTA: ˜80%
Removals without TEOS and EDTA: ˜20%
Removals with only TEOS: 0%

While certain embodiments of the disclosed subject matter have been described using specific terms, such description is for illustrative purposes only, and it is to be understood that changes and variations may be made without departing from the spirit or scope of the subject matter.

What is claimed is:

1. A functionalized engineered cellular magmatic that includes a foamed glass, a carboxyl group on a surface of the foamed glass and a targeting sorbent functionality directly or indirectly bonded to the surface of the foamed glass via the carboxyl group.

2. The functionalized engineered cellular magmatic of claim 1, the targeting sorbent functionality comprising a metal ion.

3. The functionalized engineered cellular magmatic of claim 2, the metal ion comprising a zinc ion or a nickel ion.

4. The functionalized engineered cellular magmatic of claim 1, further comprising a linking agent between the carboxyl group and the targeting sorbent functionality.

5. The functionalized engineered cellular magmatic of claim 4, the linking agent comprising a silicate linkage.

6. The functionalized engineered cellular magmatic of claim 1, comprising ethylenediaminetetraacetic acid bonded to the surface of the foamed glass via the carboxyl functionality, the ethylenediaminetetraacetic acid comprising the targeting sorbent functionality.

7. A method for removing an analyte from a medium comprising contacting the functionalized engineered cellular magmatic of claim 1 with the medium comprising the analyte, wherein, upon the contact, the analyte preferentially sorbs to the targeting sorbent functionality.

8. The method of claim 7, wherein the analyte comprises an environmental contaminant.

9. The method of claim 7, wherein the medium comprises water.

10. The method of claim 9, wherein the water comprises wastewater, industrial effluent, or agricultural runoff.

11. The method of claim 7, wherein the analyte comprises a toxic anion, a heavy metal, or a radionuclide.

12. A method for removing a poly-or perfluoroalkyl substance (PFAS) from water comprising contacting an engineered cellular magmatic with water comprising the PFAS, the engineered cellular magmatic comprising a foamed glass and carbon bonded or adhered to a surface of the foamed glass wherein, upon the contact, the PFAS preferentially sorbs to the engineered cellular magmatic.

13. The method of claim 12, wherein the water comprises wastewater, industrial effluent, or agricultural runoff.

14. The method of claim 12, wherein the PFAS comprises perfluorooctanoic acid, perfluorooctanesulfonic acid, perfluorononanoic acid, hexafluoropropylene oxide dimer acid, perfluorohexane sulfonic acid, perfluorobutane sulfonic acid (PFBS), or perfluoro butanoic acid (PFBA), or any combination thereof.

15. The method of claim 12, further comprising combining the engineered cellular magmatic comprising the PFAS sorbed thereto with a binder.

16. The method of claim 15, the binder comprising a grout or a cement.

17. A method for forming a functionalized engineered cellular magmatic comprising:
combining a glass with a foaming agent to form a mixture, the foaming agent comprising carbon;
subjecting the mixture to thermal treatment in the presence of oxygen, the thermal treatment creating a foamed glass and carboxyl groups on a surface of the foamed glass; and
directly or indirectly binding or adhering a targeting sorptive functionality to the foamed glass via the carboxyl groups.

18. The method of claim 17, the foaming agent comprising activated carbon.

19. The method of claim 17, further comprising subjecting the foamed glass to a further chemical or thermal oxidation step.

20. The method of claim 17, further comprising subjecting the foamed glass to a corrosive agent prior to the further chemical or thermal oxidation step.
